(19) United States
(12) Patent Application Publication
(10) Pub. No.: US 2009/0032006 A1
(43) Pub. Date: Feb. 5, 2009

(54) Wire saw process

(76) Inventors: Chul Woo Nam, Naperville, IL (US); Kevin Moeggenborg, Naperville, IL (US)

Correspondence Address: STEVEN WESEMAN;ASSOCIATE GENERAL COUNSEL, I.P., CABOT MICROELECTRONICS CORPORATION, 870 NORTH COMMONS DRIVE, AURORA, IL, 60504, US

(21) Appl. No.: 11/888,264

(22) Filed: Jul. 31, 2007

(51) Int. Cl. B28D 1/08

(52) U.S. Cl. 125/16.02; 451/446

(57) ABSTRACT

This invention provides a method for increasing the cutting performance of a wire saw, in cutting a substrate, by increasing the association of the abrasive particles in the cutting slurry and the cutting wire, the enhancement being caused by the use of thickening agents in the cutting slurry or by increasing the attraction of the abrasive particles to the cutting wire.

### FIELD OF THE INVENTION

The present invention relates to the field of wafering technology. More particularly, the present method relates to a method for enhancing abrasive coverage of a cutting wire on a wire saw or other apparatus.

### DESCRIPTION OF THE BACKGROUND OF THE INVENTION

Wire sawing is the dominant method for generating the thin substrates of semiconductor materials that, in recognition of their commonly very modest depth, are referred to as “wafers.” Wafers are essential to the integrated circuit and photo-voltaic industries. Common substrate materials subjected to “wafering” in these industries include silicon, sapphire, silicon carbide, aluminum nitride, tellurium, silica, gallium arsenide, indium phosphide, cadmium sulfide, germanium, zinc sulfide, gray tin, selenium, boron, silver iodide, and indium antimonide, among other materials.

A typical wire sawing process involves drawing a wire across a mass of substrate material, which in its unwafered state is commonly referred to as a boule or an ingot. The wire typically comprises one or more of steel, iron, metal alloy, composite material, magnetic material, diamond, stainless steel, aluminum, brass, nickel titanium, and copper, to name a few. The cutting increases in efficiency by applying abrasive particles to the interfacing surfaces of the wire and the substrate material. For this purpose, a standard cutting slurry, such as polyethylene glycol and about 50% by weight silicon carbide abrasive, is pumped over the interfacing surfaces during sawing. Other abrasive particles used in standard cutting slurry compositions may include one or more of silicon carbide, diamond, iron oxide, tin oxide, cerium oxide, silica, aluminum oxide, tungsten carbide, and titanium carbide, among others. A portion of the abrasive in the cutting slurry follows the wire as it is drawn across a surface of the boule. In so doing, the abrasive particles act to remove a portion of the substrate material from the boule, thereby widening and deepening the cut and, if the cut is located close and parallel to the surface, resulting in a wafer.

A more efficient cutting wire, in one sense, includes abrasive particles fixed to or embedded within the wire. For example, one cutting wire known in the art includes impregnated diamond particles.

The present invention set forth herein below is a useful addition to the field of wafering technology.

### SUMMARY OF THE INVENTION

An object of the present invention is to provide a wire saw cutting method where thickening agent technology or the manipulation of electric or magnetic forces act to increase the association of abrasive particles in the cutting slurry and a cutting wire as it contacts the cutting surface of a substrate. The substrate can be any material. The material preferably has characteristics suitable for use in wafer-like sheets for integrated circuits and photo-voltaics, such as silicon and the like. Such a substrate is generally a block, and with respect especially to the integrated circuit and photo-voltaic industries, is referred to as a substrate mass. The substrate mass is also commonly referred to as a boule or an ingot, and comprises in the composite or in the alternative a variety of materials, including those comprised of a single material, as further described below.

A further object of the present invention is to provide a method for cutting a substrate with a wire saw using a cutting slurry composition comprising abrasive particles and a thickening agent that imparts sheer thinning to the slurry composition. The abrasive particles are suspended throughout the cutting slurry thus providing a colloidally stable composition with enhanced shelf-life. This colloidal stability is achieved through the addition of a thickening agent to the carrier fluid. Thickening agents may include xanthan gum (XG), hydroxyethylcellulose (HEC), guar gum, methylcellulose, and polysaccharides, to name a few.

Another object of the present invention is to provide a method for cutting a substrate with a wire saw where abrasive particles within a cutting slurry composition are electrostatically or magnetically attracted and concentrated onto a cutting wire before or during the cutting of the substrate. The substrate, as described, may be any material. In one embodiment, the abrasive particles are charged through the manipulation and regulation of the cutting slurry pH at a value that is not equal to the isoelectric point (IEP) of the abrasive particle, wire coating, abrasive coating, or the wire itself. The charged abrasive particles are drawn to the oppositely-charged surface of the cutting wire. These electrostatic surface attractions result in the formation of an in situ fixed abrasive wire. In this embodiment of the present invention, the need for a viscous cutting slurry during wafering is reduced or eliminated. Moreover, a cutting slurry with lower viscosity increases the rate at which the attractive forces between the abrasive particles and the wire that are employed in the present invention can generate an in situ fixed abrasive wire. The term “in situ fixed abrasive wire” is used to refer to a wire usefully employed in the context of the present invention where abrasive particles adhere thereto in concert with application of the forces discussed further herein. The lower viscosity also allows the cutting slurry composition to be more readily pumpable, and allows less expensive fluids, such as water, to be used as a carrier fluid in a cutting slurry composition.

Yet another object of the invention is to provide a method of reducing wear on a cutting wire, comprising the steps of: (a) providing a wire; and (b) applying to the wire a cutting slurry composition that comprises an abrasive particle and a thickening agent that imparts sheer thinning to the cutting slurry composition. Preferably, the abrasive particle has an absolute hardness that is greater than 100. More preferably, the wear rate is lower as compared to a second cutting slurry composition that does not include the thickening agent.

There are numerous advantages to the embodiments of the present invention. First, because the abrasive particles are attracted to the working surface of the cutting wire, less abrasive may be required in the cutting slurry composition. In addition, a smaller diameter cutting wire may be used in the method of the present invention because of the decrease in wire wear rates. Use of a smaller diameter cutting wire reduces kerf loss in the cutting operation, and therefore, will result in more wafers being produced from a boule.

Additional objects of and applications for the invention and a more complete understanding of the invention are represented in the following drawings and description.

### BRIEF DESCRIPTION OF THE DRAWINGS

FIG. 1 is a schematic illustration of a cutting wire 62 and abrasive particles 60 according to one embodiment of the present invention.

FIG. 2 is a graph of settling height (arbitrary units) vs. time measured in days, for illustrating comparative colloidal stabilities of a cutting slurry composition of the present invention that includes ethylene glycol (EG), polyethylene glycol (PEG), or xanthan gum (XG).

FIG. 3 is a graph of cutting rate (mm²/min) vs. absolute hardness, illustrating the linear relationship between hardness of the abrasive particle used and cutting rate using the method and materials of the present invention.

### DETAILED DESCRIPTION OF THE PREFERRED EMBODIMENTS

The present invention relates to a method that increases the efficiency of wire saw cutting of a substrate. The method exploits a cutting wire-cutting slurry combination that is optimized to increase the association of the abrasive particles and the cutting wire, which results in increased likelihood that an abrasive particle will lodge between and remain in contact with both the cutting wire and the substrate being sawed.

The substrate subjected to the cutting method of the present invention can be any material. Preferably, the substrate is one or more of silicon, sapphire, silicon carbide, aluminum nitride, tellurium, silica, gallium arsenide, indium phosphide, cadmium sulfide, germanium, zinc sulfide, gray tin, selenium, boron, silver iodide, and indium antimonide, among other materials. More preferably, the substrate is silicon or sapphire. Most preferably, the substrate is silicon.

In one embodiment, the present invention involves thickening agent technology and/or manipulation of electric or magnetic forces applied to a cutting slurry and a cutting wire. Effective use of the present invention results in the cutting wire becoming coated, or associated, with otherwise loose abrasive particles before or as the wire contacts a cutting surface to which it is applied. This coating of the wire with the abrasive particles is referred to herein as an in situ fixed abrasive wire.

The abrasive particles suitable for use in the present invention comprise a material having sufficient hardness to cut a substrate. Sufficient hardness is determined, generally, with respect to the hardness of the substrate that is desirably cut, where a suitable abrasive particle has a hardness value that is greater than that of the substrate. Hardness can be measured by the ability of a material to scratch recognized materials on the Mohs scale, which is well-known in the field of mineralogy. The Mohs scale is based on 10 minerals of increasing hardness. The hardness of a tested material is defined as the ordinal number of the hardest material of the Mohs scale that the tested material can scratch and/or the softest material that can scratch the tested material. In pertinent part of the Mohs scale for this discussion, the materials used to define Mohs hardness 7-10 are quartz (SiO₂), topaz (Al₂SiO₄(OH—, F—)₂), corundum (Al₂O₃) and diamond (C), respectively. Accordingly, a material that can scratch quartz but not topaz is said to have a hardness on the Mohs scale of 7.5.

This relative measure of Mohs hardness can be refined by measuring absolute hardness with a sclerometer, which is an instrument that is generally available for mineralogical studies. It is used to measure hardness by applying pressure on the tested material so that it presses against a moving diamond point until a scratch occurs. The amount of pressure is recorded as a direct indicator of the hardness of the tested material. Using a sclerometer, the absolute hardness values for the minerals that define Mohs scale 7-10 are, respectively, 100, 200, 400, and 1600.

With respect to defining abrasive particles that are usefully employed in the context of the present invention, the abrasive particles have a Mohs hardness of greater than seven or an absolute hardness of greater than about 100. The requirement for abrasive particles used in the present invention having a hardness greater than seven on the Mohs scale stems from the observed inability of silica particles to effectively cut a silicon boule using slurry media based on current methodology or that of the present invention, as noted below in Example 8. More preferably, the Mohs hardness of the abrasive particles is at least eight, which particles have an absolute hardness of about 200 or more. Even more preferably, the Mohs hardness is between about 7.5 and about 10. In another preferred embodiment, the abrasive particles have a Mohs hardness of about eight or greater. Most preferably, the Mohs hardness of the abrasive particles used in the context of the present invention is between about 8 and about 10 or between about 8.5 and about 9.5.

With respect to absolute hardness measurements, preferred abrasive particles used in the context of the present invention have sclerometer readings of greater than 100. More preferably, the absolute hardness of the abrasive particles is 1600 or less, and yet more preferably, about 1250 or less; in either of these cases, the noted absolute hardness values define the maximum of a range whose minimum is at least greater than the absolute hardness of silica. Preferably, the minimum absolute hardness of the abrasive particles is about 150, about 200, about 250, about 300, about 350, or about 400. Yet more preferably, the abrasive particle has an absolute hardness of between about 150 and 1600, between about 150 and about 1250, between about 200 and about 1250, between about 300 and about 1250, between about 400 and about 1250, between about 500 and about 1250, between about 750 and about 1250, or between about 1000 and about 1250. Even more preferably, the abrasive particle has an absolute hardness that is between about 400 and about 750 as an approximate minimum to a maximum of about 1600, about 1500, about 1400, about 1300, about 1200, about 1100, about 1000, or about 900. Most preferably, the minimum hardness is between about 600 and 750. In preferred embodiments, the abrasive particle has a hardness quality that exceeds that of quartz, topaz, or corundum. In another preferred embodiment, the abrasive particle has a hardness quality that approximates 120% that of quartz; more preferably, the abrasive particle has a hardness quality that is between about 80% and 120% that of topaz or corundum. In yet another embodiment, the abrasive particle has a hardness quality that approximates at least about 60%, at least about 70%, at least about 75%, at least about 80%, at least about 85%, at least about 90%, or at least about 95% that of diamond.

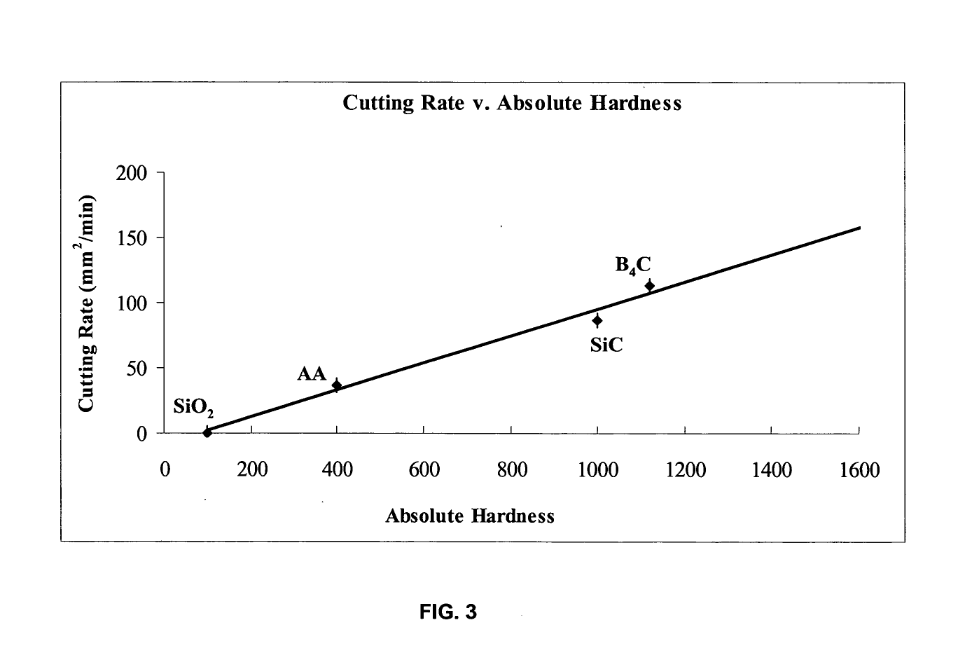

The hardness of the abrasive particle used in the present invention must be at least equal to the hardness of the substrate subjected to the cutting method. Considering abrasive particles of similar size and shape, the cutting rate is directly dependent upon the hardness of the abrasive particle used. That is, the harder the abrasive particle, the greater the cutting rate. Accordingly, for cutting a silicon boule, for example, one can use abrasive particles comprised of α-alumina and realize cutting rates of about 35 to about 50 mm²/min. Using a harder abrasive particle, say that of silicon carbide or boron carbide, one can realize cutting rates of between about 75 to about 125 mm²/min. As depicted in FIG. 3 and discussed in Example 8, there is a linear relationship between absolute hardness and cutting rate such that one may choose a desired cutting rate and thereby determine the appropriate hardness of the abrasive particle preferably used in the context of the present invention.

Preferably, a suitable material has magnetic or electric properties that can be manipulated. Materials usefully employed to form the abrasive particles include, but are not limited to, silicon carbide, diamond, iron oxide, tin oxide, tungsten carbide, boron carbide, boron nitride, and titanium carbide. The preferred material is silicon carbide. The particle size of the abrasive particles preferably range in diameter from between about 1 nm to 500 μm, more preferably from between about 500 nm to about 250 μm, yet more preferably from about 1 μm to about 100 μm, and most preferably from about 5 μm to about 50 μm.

In another embodiment of the present invention, a cutting slurry composition including at least abrasive particles, a carrier fluid, and a thickening agent is employed. The carrier fluid can be aqueous or nonaqueous; preferably, the carrier fluid is aqueous. Suitable aqueous carrier fluids include water and alkylene glycols. Preferred alkylene glycols used in the context of the present invention include ethylene glycol (EG), polyethylene glycol (PEG), and polypropylene glycol (PPG). More preferred carrier fluids are water, EG, and PPG; yet more preferred is water.

The thickening agent preferably has the characteristic of high viscosity at no or low sheer and reduced but stable viscosity at moderate to high sheer conditions, such as that experienced in the context of a wire saw operation. In the context of the present invention, this characteristic is defined as “sheer thinning,” which is the phenomenon of the slurry viscosity decreasing with increasing sheer force. An opposite fluid property is called “sheer thickening,” in which case the viscosity increases with increasing sheer force. Accordingly, a preferred thickening agent of the present invention increases the viscosity of a fluid to which it is added, thereby enhancing particle suspension and wire coating properties of the carrier fluid, for example. Moreover, these characteristics lend colloidal stability to the cutting slurry product. Additionally, the preferred thickening agent imparts the properties of sheer thinning to the cutting slurry. Accordingly, a preferred thickening agent of the present invention imparts sheer thinning to the cutting slurry during the cutting process and enhances amount of the abrasive particles transported to the cutting wire and substrate interface. Any suitable thickening agent having these properties is preferably used with the present invention. Preferred thickening agents also are substantially unaffected by changes in ionic strength or temperature of the cutting slurry. Thus, preferred thickening agents have characteristics that contribute to a long shelf-life and stability under both storage and cutting conditions. Preferred thickening agents used in the present invention include, but are not limited to, xanthan gum (XG), hydroxyethylcellulose (HEC), guar gum, starch, cellulose, methoxyethyl cellulose, and methylcellulose, to name a few. Other polysaccharides are usefully employed as thickening agents as well. More preferred thickening agents include XG and HEC; most preferred is XG.

The thickening agent is added to the carrier fluid at the preferred weight percent range of about 0.1% to about 1%; more preferred, of about 0.2% to about 0.75%; yet more preferred, of about 0.25% to about 0.6%. When XG is selected as the thickening agent, the preferred weight percent is at least about 0.1%; more preferred, the weight percent is of a range between about 0.1% to about 0.7%; yet more preferred, the weight percent is of a range between about 0.2% to about 0.4%. When HEC is selected as the thickening agent, the preferred weight percent is of a range between about 0.1% to about 1%; more preferred the weight percent is of a range between about 0.1% to about 0.7%; the weight percent yet more preferred is at least about 0.25%.

As employed in the present invention, abrasive particles present in a cutting slurry composition preferably constitute from about 10% to about 80% by weight of the composition; more preferably, from about 20% to about 70%; yet more preferably, from about 30% to about 60%; and most preferably, from about 45% to about 55%. In one embodiment, the cutting slurry composition comprises from about 45% to about 55% silicon carbide (SiC) by weight, which may be stabilized in a slurry medium that is preferably comprised of a carrier fluid in the presence of from about 0.3% to about 0.4% by weight XG. Preferred carrier fluids used in the slurry medium include water and polyalkylene glycols, such as EG, PEG, PPG, and the like, and combinations thereof.

The cutting wire wears in the course of cutting substrates, which is likely effected by frictional forces between the cutting wire and the substrate being cut. The thickening agent selected for the cutting slurry impacts the rate of wear on the wire. Preferably, one employs a thickening agent in the cutting slurry composition that has the ability to hold the abrasive particles stably, thereby potentiating the quantity of them in place at the cutting surface. The thickening agent of the present invention imparts sheer thinning characteristics to the cutting slurry. The effect of the preferred thickening agent is to cause or be associated with a decreased rate of wear of the cutting wire. The rate of wear is preferably evaluated by comparing the rate of failing of a cutting wire when used with the same materials and methods as used in the context of this present invention apart from the choice of thickening agent included in the cutting slurry composition. Alternatively, one can evaluate the rate of wear by measuring the diameter of the cutting wire over time of use with and without the preferred thickening agent included in the cutting slurry composition. Accordingly, in a method for reducing the rate of wear of a cutting wire, one preferably includes a thickening agent that imparts sheer thinning characteristics in the cutting slurry composition over the time of cutting.

In one embodiment, the targeting of the abrasive particles to the cutting wire is accomplished in concert with the application of attractive and repulsive forces, such as, for example, electrostatic forces. The electrostatic forces present in the cutting slurry can be envisioned as a surface charge on the abrasive particles. One can control the net charge exhibited by an abrasive particulate in the cutting slurry by regulating the pH of the slurry medium. Another method of controlling the net charge on an abrasive particle is by associating charged molecules with the abrasive particles; preferably, the charged molecules are polymers. For example, cationic or anionic polymers may be coated or adsorbed to the abrasive particles. Examples of such polymers include, but are not limited to, polyacrylate or methacrylate polymers, polydiallyldimethylammonium chloride (polyDADMAC), and poly[(methacryloyloxy)ethyl]trimethylammonium chloride (polyMADQUAT).

For cutting slurries whose abrasive particles are intended to be attracted to the cutting wire by means of electrostatic forces, it is preferred to identify the location of the isoelectric point (IEP) of the abrasive particles on the pH scale. At the IEP, repulsive forces between individual abrasive particles are minimized, which may allow the abrasive particles to aggregate due to the underlying attractive van der Waals forces of typical particles. The van der Waals forces are unique to a particular abrasive material, and cannot be manipulated. In general, the more remote the cutting slurry pH is from the IEP, the greater the abrasive particle surface charge, all of which will be the same and thus repulsive inter se. This repulsive force minimizes clumping of the abrasive particles. In consequence, the repulsive force also contributes to the stability of the cutting slurry composition. Another technical approach to understand stabilization of the composition is gained by measuring the zeta potential, as understood in the art. At about 2 to 3 pH units from the IEP in either direction, there is sufficient net charge associated with the respective abrasive particles such that the Coloumbic repulsion of the net charge per particle overcomes the van der Waals forces between the same particles. In consequence, a zeta potential value can be calculated in such a colloid that is consistent with stabilization of the cutting slurry composition. A zeta potential in the abrasive particles of +20 mV, for example, is usually sufficient for stabilization. It is preferred to have a stabilized cutting slurry composition not only for its extended shelf-life characteristic, but for promoting controlled interaction between the abrasive particles and the cutting wire during sawing as well.

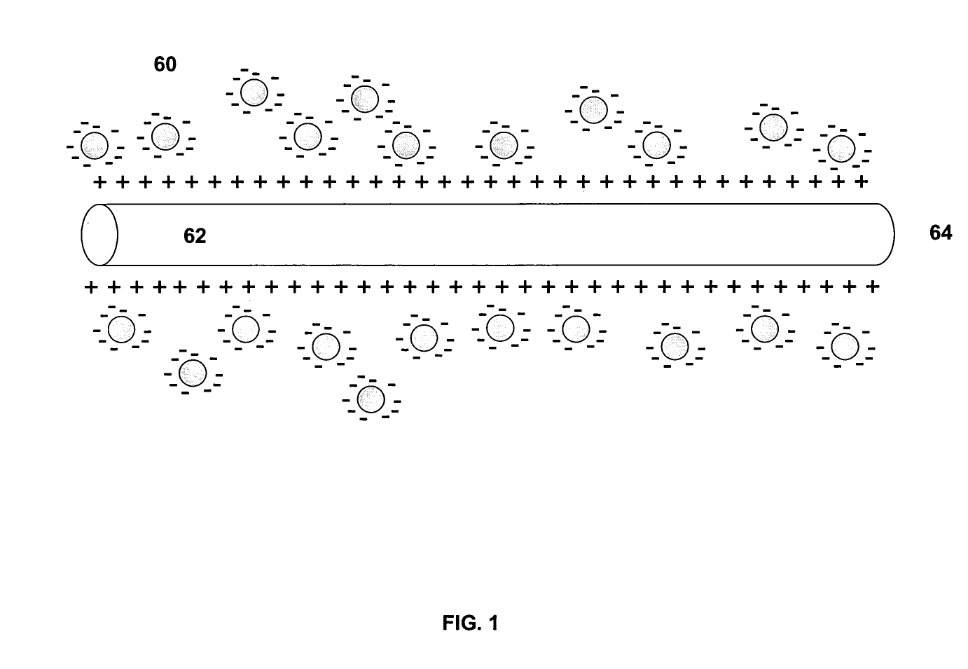

According to one aspect of the present invention, an aqueous cutting slurry including abrasive particles is employed for the wafering of a polycrystalline silicon boule using a wire saw. The abrasive particles are preferably concentrated onto a steel cutting wire used in the wafering process. The concentration of the abrasive particles is believed to occur due to electrostatic attraction, as depicted in FIG. 1. As shown there, negatively-charged abrasive particles 60 are electrostatically drawn to a positively-charged surface of the steel cutting wire 62. The electrostatic surface attractions preferably result in the formation of an in situ fixed abrasive wire 64.

The abrasive particles 60 can be any of those set forth above. The pH of the cutting slurry medium is selected to be remote from the respective IEPs of the wire and the abrasive particles 60. Preferably, the cutting slurry medium pH is selected so that the net charge on the wire and the abrasive particles are opposite.

The material used as the cutting wire can be any metal or composite material. Preferably, the material is steel, stainless steel, coated steel, or stainless steel with metal cladding; more preferably, the material is stainless steel or coated steel. In one embodiment, the cutting wire material is spray-coated with a second material that potentiates the net surface charge. For example, one can spray polyethyleneimine (PEI) onto the cutting wire, which enhances the positive net surface charge on the wire. Other wire-coating materials usefully employed include, but are not limited to, wax, polymer, sterically-adhered abrasive particles, magnetic material, magnetically-adhered abrasive particles, and electrostatically-adhered abrasive particles, among others. In particular, the polymeric materials suitable for use as a wire coating in the present invention include, but are not limited to, poly(diallyldimethylacrylamide), polyacrylic acid, and polymethacrylic acid More preferably, the wire-coating material is polyacrylic acid or poly(diallyldimethylacrylamide).

In another embodiment of the present invention, the abrasive particles are brought into contact with the cutting wire through the utilization of a particle-infused wire coating. In this embodiment, abrasive particles are preferably suspended in a viscous wax-like fluid, thus forming a particle-infused fluid. The steel cutting wire is drawn through the particle-infused fluid at a rate that allows the particle-infused fluid to coat the wire, resulting in an in situ fixed abrasive wire. In this embodiment, in addition to the particle-infused fluid, a cooling fluid may be employed during sawing in order to maximize longevity and effectiveness of the particle-infused fluid that coats the wire.

In yet another aspect of the present invention, an electrically-biased steel cutting wire is preferably drawn through a container of statically-charged SiC abrasive particles in order to effectively coat the wire with abrasive, as depicted in FIG. 1. This results in an in situ fixed abrasive wire. In this embodiment, a separate cooling fluid is preferably employed during sawing for temperature control of the cutting system.

In another embodiment of the present invention, magnetized or magnetic abrasive particles are included in an aqueous cutting slurry. The magnetized or magnetic abrasive particles can be magnetically attracted and concentrated onto a steel cutting wire when this cutting slurry is used. Suitable materials employed for magnetized abrasive particles include, but are not limited to, ferrite, steel, and carbonyl iron. Preferably, ferrite is employed. During sawing of a substrate, the magnetized or magnetic abrasive particles are magnetically drawn to the steel cutting wire. The magnetic attraction between the two surfaces results in the formation of an in situ fixed abrasive wire.

In yet another embodiment of the present invention, a large proportion of abrasive particles in an aqueous slurry can be electrically attracted onto a steel cutting wire during sawing. In this embodiment, the steel cutting wire is electrically biased with DC voltage. The voltage is preferably set so that the steel wire is charged oppositely of the abrasive particles, which respectively have a net charge as discussed above. As a result, the abrasive particles are drawn to the wire and concentrated at or on the wire, thereby forming an in-situ fixed abrasive wire. The charge on the abrasive particles is controlled by manipulation of the pH of the cutting slurry. In another aspect, the abrasive particles are coated in order to increase their net surface charge and, thereby, enhance their attraction to the oppositely charged wire. The particulate coating material can be selected, without limitation, from any of the coating materials mentioned above.

In another embodiment, the present invention relates to a method for enhancing abrasive coverage of a wire, comprising the steps of: (a) providing the wire; and (b) applying to the wire a cutting slurry composition that comprises a carrier fluid, abrasive particles; wherein (i) an electric or magnetic force acts on the wire or the abrasive particles; and (ii) the abrasive particles have an absolute hardness that is greater than 100. The method according to this embodiment can be accomplished wherein the wire is electrically biased or wherein the wire includes a coating. In one preferred alternative of this embodiment, the cutting slurry composition includes a thickening agent that imparts sheer thinning to the cutting slurry. More particularly, the method can be accomplished wherein the carrier fluid comprises a material selected from the group consisting of water and polyethylene glycol (PEG). In another variant embodiment of the present invention, the method is accomplished wherein the cutting slurry composition has a pH that is not equal to the isoelectric point (IEP) of the abrasive particulate or the coating.

In another embodiment, the present invention relates to a method for cutting a substrate, comprising the steps of: (a) providing a wire saw that includes a cutting wire; (b) applying a cutting slurry composition to the cutting wire; (c) contacting a surface of the substrate with the cutting wire; and (d) manipulating the relative positioning of the cutting wire and the surface consistent with a cutting action; wherein (i) the cutting slurry composition includes abrasive particles; and (ii) the abrasive particles are electrically or magnetically attracted to the cutting wire. The method according to this embodiment can be accomplished wherein the cutting wire is electrically biased or is magnetic or has a coating. More particularly, the method can be accomplished wherein the coating is comprised of wax, polymer, sterically-adhered abrasive particles, magnetic material, magnetically-adhered abrasive particles, or electrostatically-adhered abrasive particles. In another aspect of this embodiment, the method is accomplished wherein the cutting slurry composition has a pH that is not equal to the isoelectric point (IEP) of the abrasive particulate, coating, or the wire.

In another embodiment, the present invention relates to a method for cutting a substrate with a wire saw, comprising the steps of: (a) providing a wire; and (b) applying to the wire a cutting slurry composition that comprises an abrasive particle, a carrier fluid and a thickening agent that imparts sheer thinning to the cutting slurry composition; wherein the abrasive particle has an absolute hardness that is greater than 100. The cutting rate of a substrate using the cutting slurry of this embodiment of the present invention is greater as compared to a second cutting slurry composition that does not include the thickening agent. The method according to this embodiment can be accomplished wherein the thickening agent comprises a material selected from the group consisting of xanthan gum (XG), hydroxyethylcellulose (HEC), starch, cellulose, and methoxyethyl cellulose. This method can also be accomplished wherein the cutting slurry exhibits enhanced colloidal stability where the abrasive particles are present in an amount from about 10 wt % to about 80 wt %. In a preferred variation of this embodiment, the method is accomplished wherein the cutting slurry composition is aqueous; more preferably, the cutting slurry composition includes from about 0.2% to about 0.4% by weight xanthan gum (XG); and in an alternative preferred variation of this embodiment, the method is accomplished wherein the cutting slurry composition is aqueous and includes from about 0.4% to about 0.6% by weight hydroxyethylcellulose (HEC).

In another embodiment, the present invention relates to a method for reducing wear on a cutting wire, comprising the steps of: (a) providing a wire; and (b) applying to the wire a cutting slurry composition that comprises an abrasive particle and a thickening agent that imparts sheer thinning to the cutting slurry composition; wherein (i) the abrasive particle has an absolute hardness that is greater than 100; and (ii) the wear rate is lower as compared to a second cutting slurry composition that does not include the thickening agent. The thickening agent used in the context of this embodiment comprises a material selected from the group consisting of xanthan gum (XG), hydroxyethylcellulose (HEC), starch, cellulose, and methoxyethyl cellulose. The thickening agent used here is preferably XG or HEC; most preferably, the thickening agent used is XG.

The present invention results in a wire sawing process that is more efficient in a number of respects relative to that of the prior art. Using the method and materials disclosed here, more abrasive particles follow the wire to the cutting surface on a substrate boule because the method disclosed here substantially increases the association of abrasive particles in the cutting slurry to the wire. The association can be an adherence phenomenon or another interaction by which two materials releasably bind to one another without mechanical means. The increased association occurs in concert with the manipulation of electrostatic characteristics of the abrasive particles and the wire, as described above. In addition or in the alternative, the increased association occurs in concert with adding a thickening agent of the present invention to the slurry medium, which is also set forth above.

Per unit planar surface area of the wafered substrate, the increased association of the abrasive particles to the wire provides the following benefits: faster cutting times; reduced quantities of cutting slurry; lesser quantity of abrasive particles used; option to use lesser quality abrasive particles; option to use a thinner diameter wire (thereby reducing kerf loss); increased colloidal stability, thereby increasing shelf-life of the cutting slurry; reduced environmental and disposal/reclamation costs due to the lesser quantities of cutting slurry required.

By enabling the use of thinner diameter wire, the cutting slurries of the present invention can reduce kerf losses, and hence, more wafers can be cut from a boule. This ability is illustrated in Example 8 below. The economic impact of this ability dramatically decreases the cost per wafer at a process scale due to the greater efficiency incurred by the smaller diameter wire used. By way of illustration, one can calculate that by using a 120 μm vs. a 160 μm diameter cutting wire in a process scale cutting operation for generating 200 mm and 150 mm thickness wafers, an 11% and 13% increase in the number of wafers would be cut from a 12 inch long silicon ingot, respectively. For this calculation, it was assumed that kerf loss is the sum of wire diameter and a certain value that is dependent on abrasive particle size and/or other process variables. In this illustrative example, 45 μm of kerf loss was selected as this value, therefore for the 160 μm and 120 μm wires, total kerf loss would be 205 mm and 165 mm, respectively.

Once a wafer is generated in the wire cutting process of the present invention, the wafer is optionally subjected to a polishing process. The polishing process is usually employed when the wafer will be used for integrated circuit manufacturing, and is provided to remove any scrapes or gouges that may have damaged the planar surface of the wafer. Standard polishing materials and methods, as known in the art, are adequate.

The cutting slurry composition of the present invention can comprise a biocide. The biocide can comprise, consist essentially of, or consist of any suitable biocide. For example, suitable biocides include sodium chlorite, sodium hypochlorite, tetramethylammonium chloride, tetraethylammonium chloride, tetrapropylammonium chloride, alkylbenzyldimethylammonium chloride, alkylbenzyldimethylammonium hydroxide, and isothiazolinone. A preferred biocide used in this context is isothiazolinone. A skilled artisan will recognize that the amount of biocide in the polishing composition depends on the specific biocidal compounds employed. For illustration purposes, isothiazolinone may be used in a concentration of about 1 ppm to about 500 ppm, for example about 10 ppm to about 100 ppm, for example about 20 ppm to about 50 ppm.

The following examples, as well as the description provided above, are offered for illustrative purposes only, and are not intended to limit the scope of the present invention in any way. It will be understood by those skilled in the art that modifications can be made to the examples and described embodiments contained herein without departing from the scope and spirit of the invention. All chemicals listed herein, unless otherwise described, are available from Sigma-Aldrich of St. Louis, Mo.

### EXAMPLES

### Example 1

This example illustrates the effect of different cutting slurry compositions on the cutting performance of a wire saw on a silicon boule.

Various cutting slurry media were prepared as follows:
1. Ethylene Glycol (EG)-control medium
2. 0.2% (wt/wt) Polyacrylic Acid, Mᵥ˜1250K (PAA1250K)
3. 0.35% (wt/wt) Xanthan Gum (XG)
4. 0.5% (wt/wt) Hydroxyethylcellulose, Mᵥ˜1300K (HEC)
5.5% (wt/wt) Polyvinyl Pyrrolidine 90K (PVP 90K)

The aqueous slurry media (i.e., media 2-5 just described) were prepared with deionized water (specific conductivity≦0.4×10⁻⁷ S/m). At a pH of 7.0, at sheer rate 400 sec⁻¹, and 25° C., the slurry media respectively have the following viscosity measurements for the respective thickeners: (A) EG, 14.0 cP; (B) PAA125K, 24.0 cP; (C) XG, 17.2 cP; (D) HEC, 14.3 cP; and (E) PVP 90K, 14.3 cP. These measurements were taken with an Ares fluid rheometer (Rheometric Scientific Inc., Piscataway, N.J.) and an Orion 3 STAR pH meter (Thermo Electron Corporation).

To each of the respective slurry media, a mixture was formed by adding a 1:1 ratio by weight α-silicon carbide (SiC), i.e., each mixture was about 50% SiC by weight. The α-silicon carbide utilized in the cutting slurry is purchased from Tianjin Peng Zhan Chemcial Import-Export Co., Ltd. (Tianjin, China). The average particle size (Dv(50%)) of the α-silicon carbide particles used in the cutting slurry is 10.6 μm, as measured by a Horiba LA-910 particle size distribution analyzer (Horiba, Ltd.).

Each of the cutting slurries were employed with a single wire saw and a 0.2 mm stainless steel cutting wire mounted thereon (Model SXJ-2 from MTI Corporation Richmond, Calif.). The cutting apparatus was then employed to cut a wafer from a crystalline silicon boule having approximate cutting area dimensions of 490 mm². The rate of cutting (mm²/min) was recorded, as follows:

| | Rate of Cutting | Average | Difference from Control |
|---|---|---|---|
| Cutting Slurry | (mm²/min) | Rate | (%) |
| SiC/EG - Control | 55 | 55 | Not applicable |
| Duplicate | 55 | | |
| SiC/PAA 125K | 41 | 41 | −25 |
| SiC/XG | 61 | 64 | 16 |
| Duplicate | 67 | | |
| SiC/HEC | 63 | 62 | 13 |
| Duplicate | 61 | | |
| SiC/PVP 90K | 43 | 43 | −22 |

The results indicate that the cutting rate was increased from about 13% to about 16% when 0.35% XG or 0.5% HEC was included in the SiC/aqueous cutting slurry compositions relative to the control, SiC/ethylene glycol cutting slurry composition containing no thickening agents. Additionally, when cutting slurry media contain additives that are sheer thickening (e.g., PVP 90K), the cutting rate is decreased relative to the control. PAA 1250K, a polyvalent dispersant, also failed to provide an enhanced cutting rate. Dispersants are typically added to adsorb to the abrasive particles and stabilize the slurry by adding a charge, and hence, a steric barrier to agglomeration. In this application, however, the heavier SiC particles or agglomerates thereof still settled out and the cutting rate was lower than the EG control. These results indicate that the thickening agents that impart sheer thinning provide improved cutting performance.

### Example 2

This Example illustrates comparative colloidal stabilities for one embodiment of a cutting slurry composition of the present invention.

Three different cutting slurry compositions were prepared, each containing about 50% (wt/wt) SiC, as follows:
1. Ethylene Glycol (EG), as set forth in Example 1.
2. Polyethylene Glycol (PEG) (MW˜300)
3. 0.35% Xanthan Gum (XG), as set forth in Example 1.

The three cutting slurry compositions were respectively placed in three 100 mL graduated cylinders and observed over a 10 day period with respect to degree of settling of the contained abrasive particles, i.e., the SiC abrasive particles. The slower the rate of settling observed indicates a higher degree of colloidal stability. Degree of sedimentation was noted with respect to the level of the SiC-containing slurry medium within the graduated cylinder. Although the markings on the graduated cylinder denote milliliter volumes, the settling heights were noted in arbitrary units (a.u.).

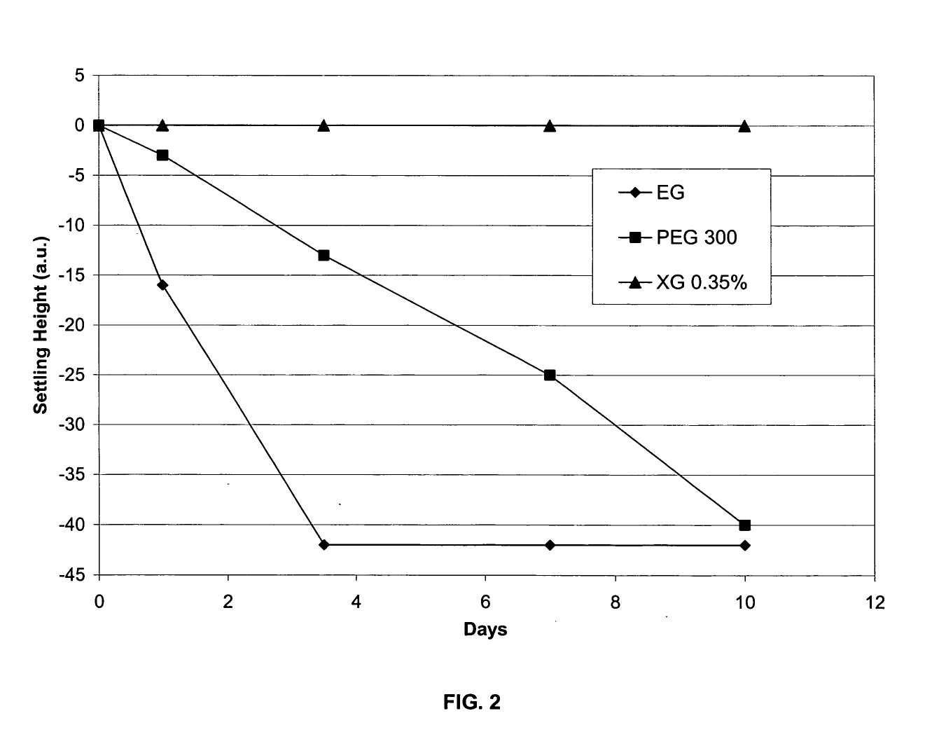

Sedimentation of the SiC particles was recorded at 0, 1, 3.5, 7, and 10 days, and the data is presented in the graph of FIG. 2. As shown there, the colloidal stability of the control EG cutting slurry having no thickening agent was seen to dramatically drop within the first day, consistent with a settling height level of just over −15 a.u. By the observation on day 3.5, the control EG cutting slurry bottomed with a settling height of between −40 and −45 a.u., at which depth it remained for the remaining observation points. The PEG-300 cutting slurry showed a retarded rate of settling relative to the control, where the SiC settled only about −3 a.u. in the first day, about −13 a.u. by day 3.5, about −25 a.u. by day 7, and about −40 a.u. by day 10. The SiC/aqueous cutting slurry containing 0.35% XG by weight maintained its full height for the entire 10 days observed, i.e., no lessening of the settling height of the SiC was detected over the 10 day experiment.

The observed lack of settling of the SiC abrasive particulate in the aqueous slurry medium that included 0.35% XG is consistent with a high degree of stability, thus extending shelf-life of the reagent to at least 30 days without apparent settling of abrasives.

### Example 3

This Example illustrates the electrostatic attraction between a cutting wire and an abrasive particulate.

A cutting slurry composition of 50% by weight SiC, buffered to pH 7.0 is employed for this experiment. The pH is selected to fall between the isoelectric points (IEP) of the SiC abrasive particulate and the steel cutting wire, thus generating opposite charges on the abrasive and the wire. Accordingly, at pH 7, which is approximately 4-5 pH units above the IEP of SiC, the SiC abrasive particles are negatively-charged. Additionally, at pH 7, the surface of the steel cutting wire is positively charged. Thus, the negatively-charged SiC particles are drawn to the positively-charged surface of the steel cutting wire.

The electrostatic surface characteristics noted above result in an attraction between the SiC abrasive particles and the steel wire, and result in the formation of an in situ fixed abrasive wire.

### Example 4

This Example illustrates a method for altering the net charge at a surface by applying a coating.

A steel cutting wire is spray-coated with polyethyleneimine (PEI). PEI has characteristics whereby it readily dries and fixes onto a surface thereby providing a positive net-surface charge at pH 7. At the same pH, the surface of the SiC abrasive particles is negatively-charged. Accordingly, contacting the steel wire with the SiC/XG cutting slurry as set forth at Example 1 results in a large proportion of the SiC particles being drawn to the cutting wire, thereby forming an in situ fixed abrasive wire.

### Example 5

This Example illustrates one method for electrostatically attracting abrasive particles from a cutting slurry onto a cutting wire during the wafering of a silicon boule using a wire saw.

A standard wire saw is employed in the silicon boule cutting process, such as Model SXJ-2 from MTI Corporation (Richmond, Calif.). The SXJ-2 wire saw has wire traveling speed capabilities of 0-5 mm/sec and rotation speed capabilities of 0-1295 rpm. Standard wire, such as stainless steel wire purchased from MTI Corporation, is employed as the cutting wire in conjunction with the SXJ-2 wire saw. The stainless steel wire is 200 μm in diameter and 840 mm in length. Additionally, the stainless steel wire is spray-coated with polyethyleneimine (PEI) in order to achieve a positively-charged cutting wire surface during operation of the wire saw.

A cutting slurry is prepared by combining deionized water and 10 wt % α-silicon carbide, and adjusting the pH to 7.0. The α-silicon carbide utilized in the cutting slurry is purchased from Tianjin Peng Zhan Chemcial Import-Export Co., Ltd. The average particle size (Dv(50%)) of the α-silicon carbide particles used in the cutting slurry is 10.6 μm, as measured by a Horiba LA-910 particle size distribution analyzer (Horiba, Ltd.). The aqueous slurry is prepared with deionized water. All pH measurements are carried out with a standard pH meter calibrated against standard aqueous buffer solutions.

During the operation of the SXJ-2 wire saw, the cutting wire speed is set at 4 m/sec. Additionally, the cutting wire tension is monitored and adjusted throughout the cutting process. The cutting slurry is administered to the silicon boule and cutting wire at a rate of 30 mL/min using a standard peristaltic pump. Control over the pH of the cutting slurry during its administration dictates the surface charge of the α-silicon carbide particles. At a pH of 7, the α-silicon carbide particles are negatively-charged, and the PEI coating on the stainless steel wire has a net-positive charge. The oppositely charged surfaces cause the α-silicon carbide particles to be drawn to the cutting wire. These electrostatic surface attractions result in the formation of an in situ fixed abrasive wire.

As compared to current standard wire cutting methods, the manipulation of attractive electrostatic forces between the cutting wire and the abrasive particles included in the cutting slurry composition results in lesser amounts of abrasive particles required during wafering, shorter cutting times, and smoother wafer surfaces that require less grinding and polishing to achieve finished products.

### Example 6

This Example illustrates one method for magnetically attracting abrasive particles from a cutting slurry onto a cutting wire during the wafering of silicon boule using a wire saw.

A standard wire saw in combination with a standard stainless steel wire are employed, as described in Example 5 hereof.

A cutting slurry is prepared by combining deionized water and 10 wt % magnetic ferrite powder. The aqueous slurry is prepared with deionized water (specific conductivity≦0.4×10⁻⁷ S/m). During the operation of the SXJ-2 wire saw, the cutting wire speed is set at 4 m/sec. Additionally, the cutting wire tension is monitored and adjusted throughout the cutting process.

The cutting slurry is administered to the silicon boule and cutting wire at a rate of 30 mL/min using a standard peristaltic pump, as described in Example 5. During cutting of the silicon boule, the magnetic ferrite particles are attracted to the steel cutting wire. This magnetic attraction results in the formation of an in situ fixed abrasive wire.

As compared to current standard wire cutting methods, the magnetic forces between the cutting wire and the abrasive particles result in lesser amounts of abrasive particles required during wafering, shorter cutting times, and a smoother wafer surface that requires less grinding and polishing to achieve a finished product.

### Example 7

This Example illustrates one method for electrically attracting abrasive particles from a cutting slurry onto a biased-cutting wire during the wafering of silicon boule using a wire saw.

A standard wire saw in combination with a standard stainless steel wire are employed, as described in Example 5 hereof.

A cutting slurry is prepared by combining deionized water and 10 wt % α-silicon carbide. The aqueous slurry is prepared with deionized water (specific conductivity≦0.4×10⁻⁷ S/m). The α-silicon carbide utilized in the cutting slurry is purchased from Tianjin Peng Zhan Chemcial Import-Export Co., Ltd. The average particle size (Dv(50%)) of the α-silicon carbide particles used in the cutting slurry is 10.6 μm, as measured by a Horiba LA-910 particle size distribution analyzer.

During the operation of the SXJ-2 wire saw, the cutting wire speed is set at 4 m/sec. Additionally, the cutting wire tension is monitored and adjusted throughout the cutting process. The cutting slurry is administered to the silicon boule and cutting wire at a rate of 30 mL/min using a peristaltic pump, identified in Example 5. During cutting of the silicon boule, a potential opposite that of the α-silicon carbide particles is applied to the stainless steel cutting wire using a DC circuit. Typically a low voltage is applied, for example about 1 volt to about 20 volts. The voltage, however, may be adjusted to optimize the cutting performance required.

The α-silicon carbide particles are attracted to the biased-stainless steel cutting wire, which results in the formation of an in situ fixed abrasive wire.

As compared to current standard wire cutting methods, the attractive forces between the biased-cutting wire and the cutting particulate results in lesser amounts of abrasive particles required during wafering, shorter cutting times, and smoother wafer surfaces that require less grinding and polishing to achieve finished products.

### Example 8

This Example illustrates the effect of different abrasives in a cutting slurry where xanthan gum (XG) is used as a thickener.

An aqueous solution of 0.3% XG was prepared and adjusted to pH 8.0. To this solution each of three different abrasives were added to a final concentration of 50% on a weight basis. The abrasives were α-silicon carbide (SiC, Tianjin Peng Zhan Chemcial Import-Export Co., Ltd), boron carbide (B₄C, UK Abrasives, Northbrook, Ill.), and α-alumina (AA, Saint-Gobain). The average particle size (Dv(50%)) of the above abrasive particles were between 10 to 11 μm, as measured by a Horiba LA-910 particle size distribution analyzer (Horiba, Ltd.).

Each of the cutting slurry media were employed with a single wire saw and a 0.2 mm stainless steel cutting wire mounted thereon (Model SXJ-2 from MTI Corporation Richmond, Calif.). The cutting apparatus was then used to cut a wafer from a crystalline silicon boule having approximate cutting area dimensions of 490 mm². The rate of cutting (mm²/min) was recorded, as follows:

| | Abs. | Rate of | | Difference |
|---|---|---|---|---|
| | Hardness | Cutting | Average | from Control |
| Cutting Slurry | of Abrasive | (mm²/min) | Rate | (%) |
| SiC/XG- Control | 1000 | 85 | 87 | Not applicable |
| Duplicate | | 89 | | |
| B₄C/XG | 1120 | 113 | 113.5 | +30 |
| Duplicate | | 114 | | |
| AA/XG | 400 | 37 | 37 | −57 |

These data were also used to generate a graph of cutting rate using the various cutting slurries versus the absolute hardness of the abrasive particle included in the respective cutting slurries. As can be seen in FIG. 3, this graph is consistent with there being a linear relationship between hardness of the abrasive particle used and cutting rate using the method and materials of the present invention.

The results indicate that the cutting rate was increased 30% by using B₄C, but decreased by 57% using AA. B₄C has a Mohs hardness value that is higher than SiC, which has a Mohs hardness value that is higher than that of AA.

To further identify the performance of abrasive particles having a hardness that is less than that of AA, silica (SiO₂) particles were employed. Cutting slurries comprising SiO₂ abrasive particles, with and without a thickening agent, were tested under the conditions described in this example (data not shown). There was no noticeable cutting of the silicon boule. However, in view of the linear relationship shown graphically in FIG. 3 between cutting rate and hardness of the abrasive particle used, the method disclosed here can cut a silicon boule using abrasive particles that are harder than SiO₂ and softer than AA.

This experiment illustrates that abrasive particles with the hardness of SiO₂ or lower will not effectively cut a silicon boule. In view of the demonstrated linear relationship between hardness and rate of cutting shown in FIG. 3, one can see that abrasive particles having a hardness greater than that of SiO₂ are indicated to provide cutting of a silicon boule, and that the rate of cutting increases with increasing hardness of the abrasive particle employed. Clearly, abrasive particles having a hardness that is about that of AA and above will handily cut the silicon boule. Using abrasive particles having decreasing hardness starting with that of AA, the rate of cutting decreases until such cutting ceases to be observed using abrasive particles having the hardness of silica and below.

### Example 9

This Example illustrates the effects on wire wear during the cutting operation for different cutting slurries.

Two different cutting slurries were prepared. The first contained 0.3% xanthan gum (XG) in deionized water with pH adjusted to 8.0. The second slurry contained polyethylene glycol (PEG) with a molecular weight about 300. Silicon carbide abrasive particles were added to each slurry in a 1:1 (by weight) ratio. The slurries were then used with the SXJ-2 single wire saw described above to cut crystalline silicon boules having approximate cutting area dimensions of 490 mm².

For each trial a new wire (85 cm length) having an initial diameter of 197 μm was installed. The cutting process was run continuously, making consecutive slices in the silicon boule, until the wire failed or broke. The wire diameter was measured after each slicing step was completed. The results, are shown in the table below:

| | Initial | Diameter | Diameter | Diameter | Diameter |
|---|---|---|---|---|---|
| | wire | after | after | after | after |
| Cutting | diameter | 1^{st} cut | 2^{nd} cut | 3^{rd} cut | 4^{th} cut |
| Slurry | (μm) | (μm) | (μm) | (μm) | (μm) |
| SiC/XG | 197 | 186 | 153 | 135 | broken |
| SiC/PEG | 197 | 159 | 72 | NA | NA |
| | | | (wires | | |
| | | | broken | | |
| | | | for two | | |
| | | | tests out of | | |
| | | | three trial) | | |

The results demonstrate that use of the XG based cutting slurry correlated with making at least 3 complete cuts before the wire failed. By comparison, with the PEG based slurry, the cutting wires generally failed in the midst of cutting the second boule.

### INDUSTRIAL APPLICATION

An advantageous application for the invention lies in improving wire saw cutting efficiency and reducing cutting slurry costs by reducing the amount of abrasive particulate required during sawing, achieving shorter cutting times, and attaining a smoother wafer surface that requires less grinding and polishing in order to achieve a finished product.

We claim:

1. A method for cutting a substrate with a wire saw, comprising the steps of:
(a) providing a cutting wire; and
(b) applying to the cutting wire a cutting slurry composition that comprises a carrier fluid and abrasive particles having an absolute hardness that is greater than 100; and
(c) increasing an association of the abrasive particles to the cutting wire by:
(i) adding a thickening agent that imparts sheer thinning to the cutting slurry composition, or
(ii) forming an electric or magnetic attraction between the wire and the abrasive particles, or
combinations thereof.

2. The method of claim 1, wherein the wire is electrically biased.

3. The method of claim 1, wherein the wire includes a coating.

4. The method of claim 1, wherein the carrier fluid is aqueous.

5. The method of claim 1, wherein the thickening agent comprises a material selected from the group consisting of xanthan gum (XG), hydroxyethylcellulose (HEC), guar gum, starch, cellulose, and methoxyethyl cellulose.

6. The method of claim 3, wherein the cutting slurry composition has a pH that is not equal to the isoelectric point (IEP) of the abrasive particles or the coating.

7. A method for cutting a substrate, comprising the steps of:
(a) providing a wire saw that includes a cutting wire;
(b) applying a cutting slurry composition to the cutting wire;
(c) contacting a surface of the substrate with the cutting wire; and
(d) manipulating the relative positioning of the cutting wire and the surface consistent with a cutting action;
wherein (i) the cutting slurry composition includes abrasive particles; and (ii) the abrasive particles are electrically or magnetically attracted to the cutting wire.

8. The method of claim 7, wherein the cutting wire is electrically biased.

9. The method of claim 7, wherein the cutting wire is magnetic.

10. The method of claim 7, wherein the cutting wire has a coating.

11. The method of claim 10, wherein the coating is comprised of wax, polymer, sterically-adhered abrasive particles, magnetic material, magnetically-adhered abrasive particles, or electrostatically-adhered abrasive particles.

12. The method of claim 11, wherein the cutting slurry composition has a pH that is not equal to the isoelectric point (IEP) of the abrasive particles, coating, or the wire.

13. A method for cutting a substrate with a wire saw, comprising the steps of:
(a) providing a cutting wire; and
(b) applying to the cutting wire a cutting slurry composition that comprises a carrier fluid, an abrasive particle and a thickening agent that imparts sheer thinning to the cutting slurry composition;
wherein the abrasive particle has an absolute hardness that is greater than 100.

14. The method of claim 13, wherein the thickening agent comprises a material selected from the group consisting of xanthan gum (XG), hydroxyethylcellulose (HEC), guar gum, starch, cellulose, and methoxyethyl cellulose.

15. The method of claim 13, wherein the abrasive particles are present in an amount from about 10 wt % to about 80 wt %.

16. The method of claim 13, wherein the substrate is silicon.

17. The method of claim 13, wherein the cutting slurry composition includes from about 0.1% to about 0.7% by weight xanthan gum (XG).

18. The method of claim 13, wherein the cutting slurry composition includes from about 0.2% to about 0.4% by weight xanthan gum (XG).

19. The method of claim 13, wherein the cutting slurry composition includes from about 0.1% to about 0.7% by weight hydroxyethylcellulose (HEC).

20. The method of claim 13, wherein the abrasive particle is silicon carbide
